(19) United States
(12) Patent Application Publication
(10) Pub. No.: US 2004/0166905 A1
(43) Pub. Date: Aug. 26, 2004

(54) Radio frequency linked computer architecture

(75) Inventors: Andrew M. Cherniski, Rescue, CA (US); Ricardo Espinoza-Ibarra, Carmichael, CA (US); Michael Wortman, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/360,329

(22) Filed: Feb. 7, 2003

(51) Int. Cl. H04M 1/00

(52) U.S. Cl. 455/575.1; 455/575.5

(57) ABSTRACT

A RF-linked computer system comprises a radio tight enclosure that contains a plurality of cavities capable of accepting multiple function modules. The function modules have radio frequency communication systems that intercommunicate in multiple parallel channels and wide bandwidth within the enclosure. The RF-linked computer system further comprises an optical communication link capable of communicating to devices and systems exterior to the enclosure.

### BACKGROUND OF THE INVENTION

Organizations that rely on information technology are acutely aware that system downtime leads to lost customers, lost profit, and a soiled reputation. System availability defines the reliability of on-line enterprise to service customers and fulfill business promises.

One aspect of availability is scalability. As the number of applications and network participants increases, the amount of information that passes through servers expands. System capacity must increase steadily as demand increases. Availability relates to scalability since failures can be caused by lack of capacity as well as component failure. Available systems must also respond to changing loads and circumstances without a reduction in response.

Availability depends not only on equipment reliability but also on personnel who use, administer, and service the systems, as well as processes such as practices, system modification, backup and problem management. Some analysts have found that only a small percentage of downtime results from equipment failure and performance.

An available system reduces both unplanned downtime due to system failure or disruption, and planned downtime. Available systems are designed to rapidly survive failures by repair, upgrade, or expansion, rapidly and without reducing services.

Various techniques have been used to improve availability including configuration of redundant systems, enabling processor upgrades without interrupting a running system, support of dynamic reconfiguration, and remotely monitoring operations.

A particular example of a highly available system is a cluster of servers with N+1 redundancy on a system level. The highly available system requires a total investment and repair granularity that is extremely large. Scalability is limited to entire systems and fail-over times are typically at least in the tens of minutes.

Another specific example of a highly available system with very good serviceability is a group of bladed servers, a system with excellent availability but with high partitioning by design that is not easily used in monolithic applications with flat memory configurations.

### SUMMARY OF THE INVENTION

In accordance with some embodiments of the disclosed system, a RF-linked computer system comprises a radio tight enclosure that contains a plurality of cavities capable of accepting multiple function modules. The function modules have radio frequency communication systems that intercommunicate in multiple parallel channels and wide bandwidth within the enclosure. The RF-linked computer system further comprises an optical communication link capable of communicating to devices and systems exterior to the enclosure.

In accordance with other embodiments, a RF-linked computer system comprises a radio tight enclosure and a plurality of function modules capable of insertion into the radio tight enclosure. The function modules comprise one or more radio frequency interfaces and one or more antennas for intercommunicating with function modules within the enclosure to form a virtual bus comprising a plurality of dynamically modifiable parallel wireless communication channels.

In accordance with a further embodiment of the disclosed system, a RF-linked computer system comprises a radio-tight enclosure and a plurality of function modules including one or more function modules that can execute system arbitration functionality. The function modules intercommunicate within the enclosure via multiple parallel radio frequency channels. The arbitration functionality comprising a capability to detect presence of function modules, a capability to assess functionality and/or performance of the function modules, and a capability to assign communication resources and parallel channels for intercommunication among function modules.

In accordance with other embodiments, a wireless-linked computer system comprises a radio tight enclosure that contains a plurality of cavities capable of accepting multiple function modules that can intercommunicate inside the enclosure by wireless communication. The RF-linked computer system further comprises a power line and an optical communication channel capable of interfacing to systems and devices outside the enclosure.

In accordance with a further embodiment of the disclosed system, a wireless-linked computer system comprises a radio-tight enclosure and a plurality of function modules including one or more function modules that can execute system arbitration functionality. The function modules intercommunicate within the enclosure via multiple parallel wireless channels. The arbitration functionality comprising a capability to assign wireless communication resources and channels among the plurality of function modules so that the function modules operate mutually independently on a wireless fabric in a backplane-free and communication connector-free internal environment with the function modules operating as cross-linked and autonomous system contributors.

In accordance with an additional embodiment, a computer system comprises a radio-tight enclosure, a plurality of cavities contained within the enclosure, one or more function modules capable of insertion into the cavities, and a power delivery infrastructure. The plurality of cavities are capable of accepting and holding multiple function modules. The one or more function modules further comprise a radio frequency communication system capable of intercommunicating in multiple parallel channels and wide bandwidth within the enclosure. The power delivery infrastructure is coupled to the plurality of cavities for supplying power to the one or more function modules. The power delivery infrastructure comprises the only hardware common to all function modules. The power delivery infrastructure is redundant and replaceable without disrupting computer system operation.

### BRIEF DESCRIPTION OF THE DRAWINGS

Embodiments of the invention relating to both structure and method of operation, may best be understood by referring to the following description and accompanying drawings.

FIG. 1A is a schematic pictorial diagram that depicts a radio frequency (RF) linked computer system that can be configured for extensibility and high availability.

FIGS. 2A and 2B are schematic pictorial diagrams showing frontal and rear views of an alternative embodiment of a RF-linked computer system that includes internal bulk power supply modules and a line filter, shown by schematic circuit diagram in FIG. 2C.

FIGS. 2D and 2E are pictorial diagrams depicting power bus connections for power slots and non-power slots, respectively.

FIG. 3 is a pictorial diagram showing a RF-linked computer system that uses external power delivery, storage, and input/output interfacing to facilitate noise immunity.

FIG. 4 is a schematic block diagram illustrating an example of a power supply module that is suitable for usage in a RF-linked computer system.

FIG. 5 is a schematic block diagram illustrating an example of a functional module that is suitable for usage in the illustrative RF-linked computer

FIG. 6 is a schematic pictorial diagram showing an example of a suitable connector for connecting a functional module to a cavity.

FIG. 7 is a schematic block diagram showing an example of a suitable radio frequency interface for usage in a function module.

FIG. 8 is a highly simplified block diagram showing functional elements in various suitable processor/cache function modules and system memory (RAM) function modules.

FIG. 9 is a schematic block diagram that shows an example of an input/output (I/O) port module suitable for usage in the illustrative RF-linked computer systems.

FIG. 10 is a simplified block diagram illustrating an example of a system function module such as a system arbitration function module or a system management and control function module.

FIG. 11 is a schematic flow chart that describes operation of the RF-linked computer systems.

FIG. 12 is a flow chart depicting operations of a suitable initialization sequence.

FIG. 13 is a flow chart showing actions of a suitable arbitration operation.

### DETAILED DESCRIPTION

What is desired is an architecture that improves availability, scalability, and serviceability.

A computer architecture uses a simplified design that eliminates points of failure by eliminating physical interconnects among functional blocks and replacing the physical interconnects with RF communications. The architecture addresses bandwidth constraints on multiple processor communications by enclosing the system in a RF tight housing and communicating internally concurrently in many frequency bands. The system further eliminates points of failure by simplifying supply of power. In some embodiments, only DC voltage is supplied in the system using single voltage DC bus bars. Individual modules access the single voltage DC power from the bus bars and regulate power to specifications of the module.

A computer architecture can be configured so that the only hardware common to all functional modules is a power delivery infrastructure and the power infrastructure is redundant and replaceable without disrupting system operation.

A computer architecture utilizes radio frequency communication between components. The architecture can be exploited in various configurations to attain characteristics including high availability, extensibility, and scalability. Modular components can be used in a computer architecture that is capable of highly granular expandability. The modular components can be configured with high levels of functional resiliency by usage of redundant decentralized functional elements, capability to determine when a particular functionality is needed, and supplying the functionality from multiple sources.

The computer architecture is capable of high levels of system hardware availability by usage of fully redundant subsystems. The redundant subsystems can be highly modular, promoting scalability by a capacity to add additional elements and promoting serviceability and availability by enabling continued operation while faulty elements are tested, discovered, and replaced.

The modular design can be exploited to permit multiple usage of components within a platform and throughout a family of platforms. The system can be configured as a “wall of modules”, promoting customer servicing by replacement of system components on-line, while the system remains operational. A business model may be pursued that reduces or eliminates the need for service personnel for the life of the product.

The disclosed system can be configured to improve availability, scalability, serviceability, and reliability, while reducing cost. The illustrative design can be exploited to reduce costs by usage of highly modular systems with high reusability, enabling large manufacturing quantities that can result in significant cost advantages.

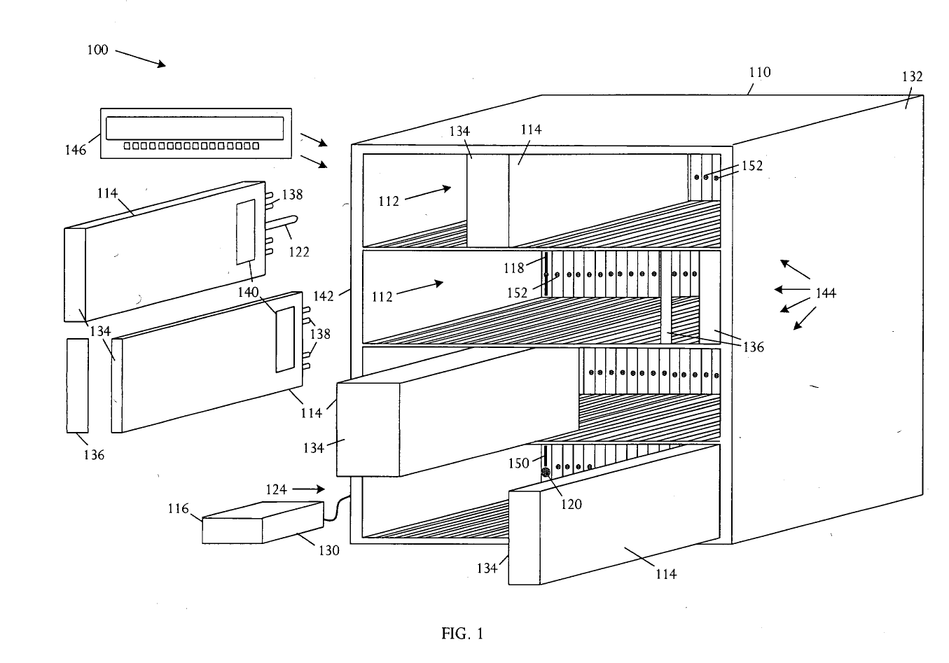

Referring to FIG. 1A, a schematic pictorial diagram depicts a radio frequency (RF) linked computer system 100 that can be configured for extensibility and high availability. The RF-linked computer system 100 comprises a plurality of modular subsystems, devices, and/or components that can communicate using radio-frequency links to one or more, or all system data buses and components in a manageability infrastructure. Radio-frequency communication between and among modules reduce or eliminate usage of backplanes and connectors while permitting a high level of cross-communication between modules and usage of autonomous system contributors.

The RF-linked computer system 100 comprises an enclosure 110, chassis, or housing with multiple cavities 112 or slots that can have consistent sizes and shapes. Consistent form of the cavities 112 allows modules 114 of various types and functionality to be entered in any cavity 112 or adjacent multiple cavities 112 with little or no restriction. In an illustrative example, the enclosure 110 is a mechanical structure formed from a metallic support frame 142 assembled to form a plurality of multiple-level planes 144. The illustrative enclosure 110 is a cubic or rectangular box with five sealed sides and one side, for example a frontal side, left open to receive a matrix of modules 114. The open frontal panel of the enclosure 110 facilitates availability since all modules can be accessed and removed from the front panel. Substantially all servicing, replacement, maintenance, and handling can be accomplished via removal and replacement of modules through the front panel. With each module 114 being relatively deep, extending essentially from the front panel to the rear panel that seats into a cavity 112, all functional elements of a module are accessible for servicing and maintenance by removal and replacement through the front panel. The deep bore of the enclosure 110 and deep modules enables reasonable volume and surface area for attaching functional components while reducing the amount of face area for a module in the front panel. Accordingly, the deep bore and narrow width of a module facilitates capabilities and performance of a module while reducing the frontal surface area that is the most likely area of radio energy leakage.

The individual planes 144 are divided into a plurality of structural cubicles or cavities 112 that accept and hold in place the functional modules 114. The individual modules 114 are installed by pushing into a cavity or cavities. Power connectors are coupled to the enclosure 110 at the rear portion of the cavities 112. As the modules 114 are pressed into the cavities 112, the modules 114 made electrical contact to the power connectors, delivering DC and/or AC power to the module.

The enclosure 110 can have an optional front panel users interface 146 that has electrical connections for communicating to the function modules 114. The front panel users interface 146 is typically constructed of materials such as metal or plastic forming the enclosure 110. The front panel users interface 146 can be attached with signal and power lines from the interior of the enclosure 110 passing through gaskets to reduce or eliminate emissions. In other embodiments, a front panel users interface 146 may interconnect with control elements inside the enclosure 110 via an optical link.

The RF-linked computer system 100 is comprised of multiple independently executing modules 114 that are connected by many parallel RF links using the entire RF spectrum.

In an illustrative embodiment, the enclosure 110 can house one or more types of customer replaceable modules 114 and power delivery assemblies. Modules 114 may include functional modules and optional AC power modules, both of which can be accessed by frontal access of the enclosure 110. In the illustrative RF-linked computer system 100, function modules 114 have fill access from the front of the enclosure 110 with a limited face area for the individual modules. The limited face area reduces the exposure surface area for a module and thus the difficulty of shielding in the radio-tight enclosure 110.

The RF-linked computer system 100 is highly scalable on the basis that a large enclosure 110 can include a large number of cavities 112 and accept a large number of modules 114. Under relatively low workloads, many or most of the cavities 112 can be left vacant with the enclosure sealed by a cover panel for later installation of modules when traffic increases. High scalability is attained both by the large number of slots within a system so that expansion is available within a cabinet, and also by capability to connect multiple cabinets with multiple cabinets communicating via optical links.

Momentary and limited area RF emissions that occur when modules are removed for servicing, replacement, or upgrade are typically sufficiently low in amplitude and in duration to be permissible. However, some embodiments may include a quiesce button that can pause internal radio emissions for the short time that leakage may occur from the enclosure 110. In some applications, arbitration modules can monitor system status and detect removal of a module or other breach of radio security, and can respond by limiting internal communications to those deemed critical to operation. Other internal communications can be delayed until the radio security breach terminates or the condition becomes critical. In some embodiments, an arbitration or management module can monitor control entries from the front panel to determine when and how to control internal communications to reduce leakage.

In some configurations, power distribution assemblies 126 receive and distribute power that is supplied from a remotely-housed power unit 130, for example in a configuration that uses negative 48 volt DC house (Telco) power or DC power. Remote housing of the power unit 130 omits components capable of failing from the enclosure 110. The RF-linked computer system 100 can omit bulk power supplies and meet power requirements by distributed voltage regulators 140 coupled locally to function modules 114. One suitable power arrangement is single rail power distribution with two bus bars for each rail including one source bar and one return bar at an appropriate voltage to supply functionality of the module. Bulk system power can be redundantly delivered in multiples of two as negative 48V DC lines. DC power can be sourced from house power, as in Telco installations or from a separate AC to DC power unit located the vicinity of the RF-linked computer system 100. Other embodiments may supply multiple power rails. The RF-linked computer system 100 can have DC bus bars 150 to supply power to the modules 114.

The single-rail power distribution system allows individual modules to access system power and convert to suitable power requirements for the particular module. Some embodiments may supply power in other forms, such as more complex forms, to suit various applications. For example, a system may have four bus bars rather than two to enable two grids of isolated independent power sources, thereby supplying redundancy in case one power system were to fail.

One typical design consideration may be to configure a module with the smallest voltage regulator 140 capable of supplying sufficient power based on module size and power requirements. Commonly the voltages to be supplied range from about one volt to higher voltages. Voltage regulators 140 are allocated and associated with individual modules 114 and are sized particularly to the specifications of the associated module 114.

In an illustrative embodiment, the enclosure 110 can be powered by a power supply 116 that delivers a suitable voltage, for example 48 volts. The enclosure 110 can be arranged as a vertical matrix of square or rectangular-shaped cavities 112. In some embodiments, the cavities 112 have a deep bore to allocate sufficient space for elements and components on a module while limiting the module's area near the front panel of the enclosure 110, thereby reducing emissions through the front side gaskets and cover plate.

The cavities 112 can be arranged within the enclosure 110 in multiple rows with the rows having multiple columns. In some embodiments, a subset of the cavities 112 can be grouped in a particular location in the enclosure 110 and allocated to receive AC power modules. In one example, a lowest cavity row 124 can be configured to accept one or more AC power distribution assemblies 126 for use when AC power is desired. Various design rules may be imposed that consign the AC power distribution assemblies 126 to a particular portion of the enclosure 110, for example particular levels, rows, columns, or sections.

The enclosure 110 is a radio tight vessel that contains a power delivery infrastructure for installed function modules 114. The enclosure 110 can be constructed from any materials with suitable strength to support a full capacity of modules 114 and with sufficient shielding to reduce or prevent radio frequency signal emissions. Examples of suitable materials include metals or sheet metals of suitable strengths and thickness, metal on plastic structures, wire matrices with sufficiently small gaps to attenuate signals, non-conductive materials covered by conductive paint, conductive wires embedded in a nonconductive matrix, and the like. Openings for inserting and removing modules can be sealed using gaskets such as beryllium fillers, flectron cloth over foam, and the like.

The characteristic of radio tightness is attained by radio tight panels 132 in the enclosure 110 and radio tight front cover plates 134 that tightly seal the front surface of the individual function modules 114. The front surfaces of adjacent function modules 114 may have electrical gaskets that facilitate sealing of the enclosure front panel. For vacant cavities 112, radio tight blank filler panels 136 seal the enclosure 110 with suitable mechanical structures to firmly hold the filler panels 136 in place.

The individual modules 114 communicate via radio frequency signaling within the radio tight enclosure 110, facilitating mutual independent operations among the modules 114.

The individual modules 114 have a common form factor and power interface 138. In some embodiments, the function modules 114 have a size that is fixed in two dimensions, depth and height, and variable in one dimension, width. The modules 114 can have a width that is an integer multiple of the width of a cavity 112 or slot so that multiple width modules 114 can be inserted as a unit into two or more adjacent cavities 112. In various embodiments, the function modules 114 may be of multiple function types. The different types of function modules may be distinguished by color coding and labeling.

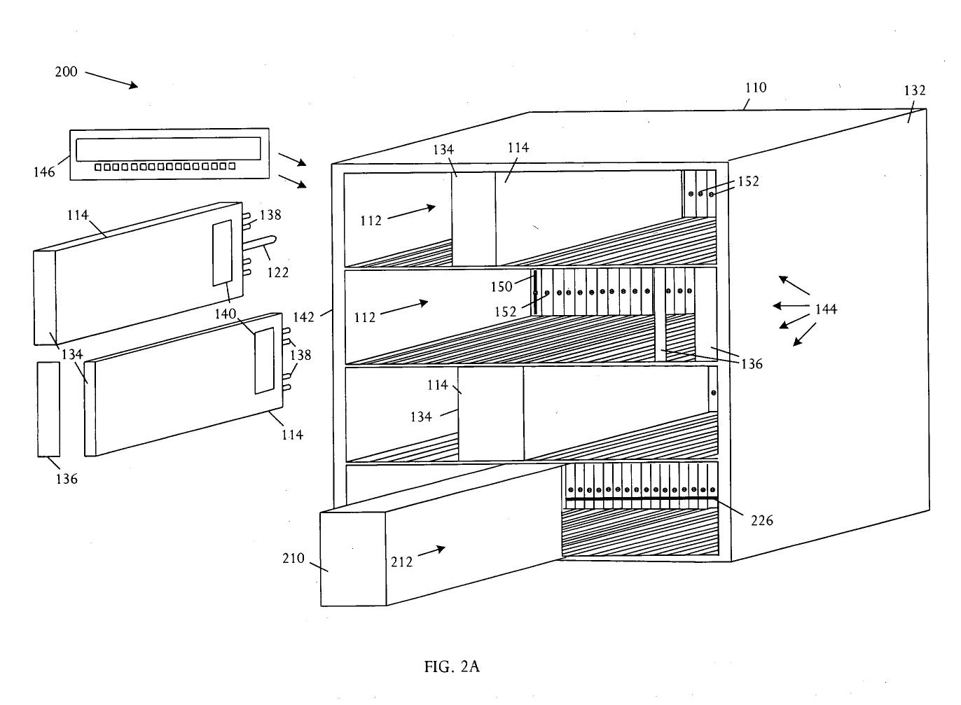

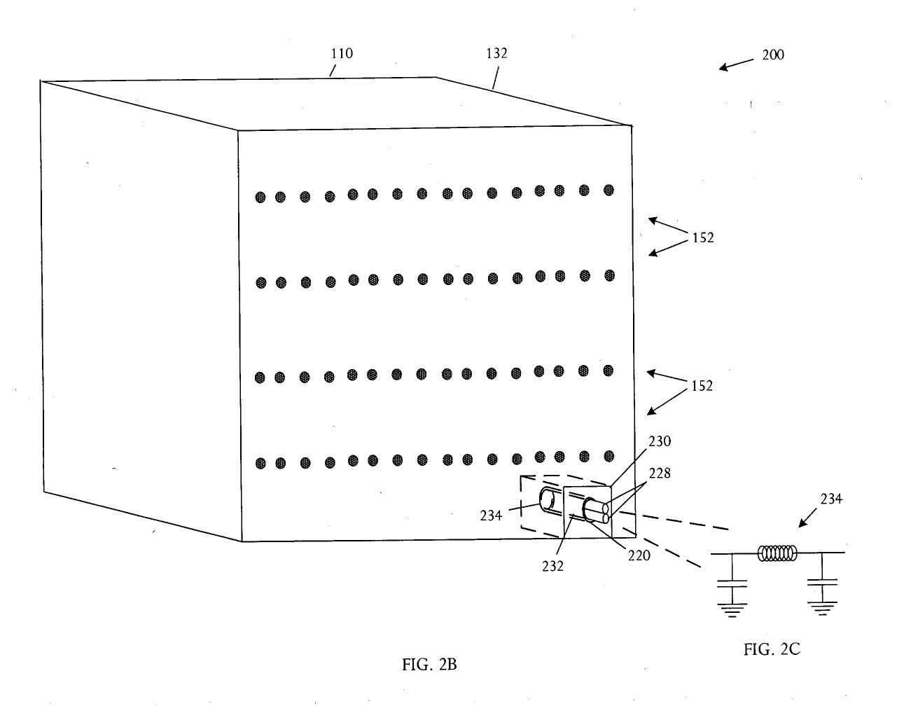

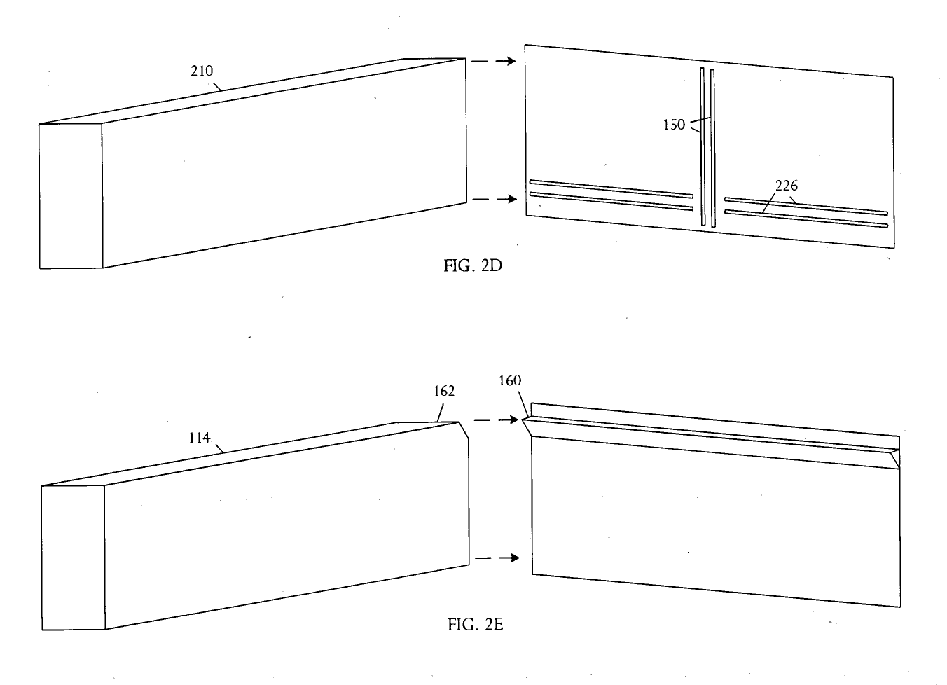

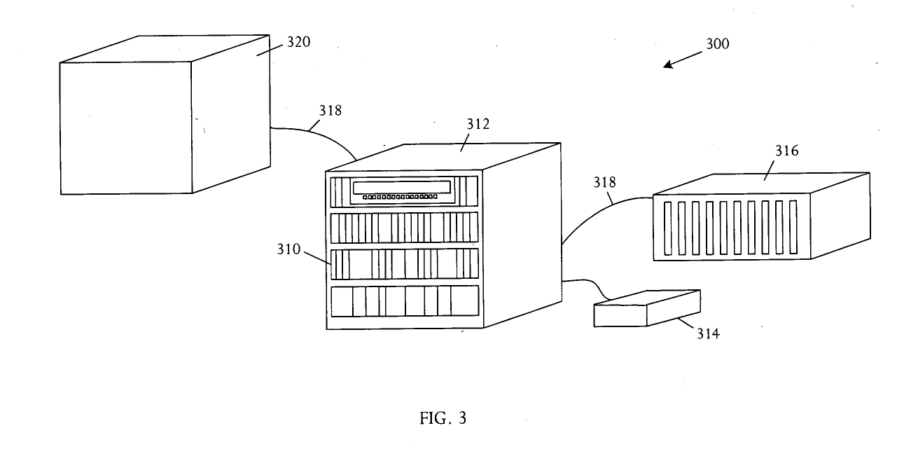

Referring to FIGS. 2A and 2B, frontal and rear view schematic pictorial diagrams depict an alternative embodiment of a RF-linked computer system 200 that includes internal bulk AC power supply modules 210. The bulk AC power supply modules 210 can be contained within the enclosure 110 and configured using the physical design rules that apply to the functional modules 114. The RF-linked computer system 200 can have AC bus bars 226 and DC bus bars 150. The DC bus bars 150 can be interleaved with the AC bus bars 226 and isolated from the DC bus 150. AC bus bars 226, if included, are used exclusively to supply power supply modules 210 that, in turn, supply DC power to the DC bus bars 150.

The bulk AC power supplies 210 connect to AC line cords 228 that enter the enclosure 110 in multiples of two through an aperture 120 in a quarantine area 230 the lower rear portion of the enclosure 110 and are directly connected to redundant AC power distribution bus bars 226 on the back panel of the enclosure 110. The aperture 120 can be configured to attain noise immunity and radio tightness, for example by having a minimum diameter that is only sufficiently large to contain the power cords 228. A line filter 234, shown in FIG. 2C, can be coupled to the AC line cords 228 for noise immunity. The AC power connection into the enclosure 110 passes though a filter 234 and connects with AC distribution bus bars 226 to AC power supplies 210 that convert to DC power and supply DC bus bars 150.

The power supply modules 210 can be modular and replaceable while the RF-linked computer system 200 remains on-line and operational. Replacement of a power supply modules 210 can be accomplished while interrupting operability of only a portion of the cavity rows and columns in the enclosure 110, and removing the power distribution assembly 126 for service from the open frontal access panel of the enclosure 110.

The power supply modules 210 have the same size constraints as the modules 114, a fixed height and depth, and a width that is a multiple of the cavity slot width, and have an additional AC power connection, typically in a rear portion of the module.

The power supply modules 210 are current sharing power sources that deliver a suitable isolated voltage, for example −48V DC, that is sufficient to supply all modules 114.

Referring to FIGS. 2D and 2E, pictorial diagrams show power bus connections for power slots and non-power slots, respectively. FIG. 2D shows an example of a bulk power supply module 210 that can insert into a cavity in a back panel, generally disposed at a 90° angle to the module 210. Power cavities can include AC bus bars 226 and DC bus bars 150. FIG. 2E shows an example of a nonpower module 114 that can insert into any cavity on the back panel including power slots and nonpower slots. In the example, the nonpower slots include a physical lockout key, here shown as a ridge or protrusion, that prevents insertion of a power supply module 210 into the nonpower slot. The nonpower function module 114 has a receptacle, here shown as a cutout or notch, that accepts the key so that the nonpower module 114 can be inserted into the nonpower slot. In this example, the nonpower modules 114 can insert into either power or nonpower slots. Power modules 210 can be inserted only into power slots.

Referring to FIG. 3, a pictorial diagram shows a RF-linked computer system 300 that uses external power delivery, storage, and input/output interfacing to facilitate noise immunity. The illustrative system 300 comprises a processing unit 310 with a radio-tight chassis 312 or enclosure and containing processing, management, control, arbitration elements and the like while off-loading functional elements that are more difficult to isolate or difficult to implement. Power is supplied to the processing unit 310 by an external DC bulk power supply 314 to improve noise immunity inside the chassis 312. The processing unit 310 can be implemented using a single internal I/O port that communicates to an input/output interface 316, such as a Peripheral Component Interconnect Express (PCI-X) interface, via an optical cable 318. A PCI-X device can communicate with multiple PCI devices capable of operating at speeds up to 133 MHz or 1 GB/s at an increased bandwidth. The PCI-X uses protocol enhancements that improve efficiency and supply more bandwidth at any clock frequency.

Although operating with only a single I/O port internal to the processing unit 310 improves noise immunity, other configurations using multiple I/O ports may be implemented.

The RF-linked computer system 300 also offloads storage devices to one or more external storage units 320 that interface with the internal I/O port via an optical cable 318. The eternal storage units 320 can be local or remotely accessed through network communications.

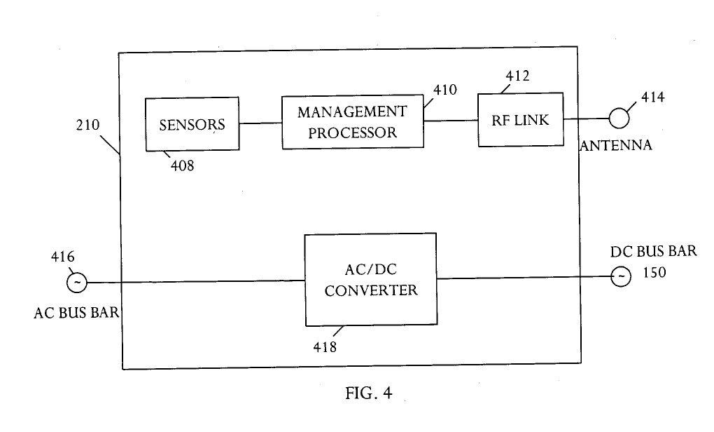

Referring to FIG. 4, a schematic block diagram illustrates an example of an AC power supply 210 that is suitable for usage in a RF-linked computer system. The AC power supply 210 can be configured in a relatively small size, for example consuming one or two cavities 112 in an enclosure 110. Multiple small size AC power supplies 210 can be included in the RF-linked computer system 200, as sufficient in a particular application, providing small granularity and flexibility to a system designer. Small granularity can be exploited so that one or more identical AC power supplies 210 can be added to a system of any size, so that volume production and economies of scale can reduce price per unit to the benefit of both consumers and producers.

The illustrative AC power supply 210 comprises one or more support processors 410, such as a management processor, and a two-way radio frequency link 412 via antenna 414 to supply robust power management support through communications with an arbitration module. The arbitration module can detect presence and functionality of the AC power supply 210, and track failures, performance declines, and preliminary indications of performance reduction or failure. In response to detection of present or preliminary indications of difficulty, the arbitration module can recruit other redundant supplies to prevent loss of support to the maintained function modules 114.

The power supply 210 can comprise sensors 408 capable of sensing parameters including DC rail level, current, temperature, and the like and predetermine impending internal failures so that redundant modules can be activated or shared among modules.

The power supply 210 receives AC power from an AC main power source via an AC bus bar 416. The AC bus bar 416 is coupled to an AC/DC converter 418 that converts the supplied AC power into DC power for use by other modules 114 and possibly other components in the enclosure 110. The AC/DC converter 418 delivers conditioned power to the DC bus bars 150 that supply a suitable voltage, for example 48V, to the back panel of the enclosure for distribution to the other functional modules 114.

Multiple redundant AC power supplies 210 may be included in a system so that failure of an individual supply does not affect operations. The management processor 410 and sensors 408 facilitate availability by detecting operating conditions and, based on the conditions, forecasting impending failures. Conditions of interest can be communicated to exterior devices via optical communications or by activating warning lights on the front panel.

In an illustrative example, the AC power supplies 210 are designated for installation in specific power cavities 212 in the bottom row of the cavity matrix. The specified power cavities 212 supply AC power through on-line replaceable AC power distribution assemblies 126. AC power supplies 210 can have a physical lockout key that prevents installation in non-power designated cavities. Various configurations of the lockout key may be configured such as a structural tab, key, bar, corner, or other member that prevents insertion of the AC power supply 210 into cavities 112 that are not intended to receive the power modules. In the example, the designated power cavities 212 do not prevent installation of non-power functional modules 114 so that various functional modules 114 can be installed in the designated power cavities 212. Accordingly, non-power functional modules 114 and the AC power supplies 210 can be commingled in the power cavities 212, if desired.

The various types of function modules 114 can be organized in any pattern that is physically possible in the system enclosure 110. In some embodiments, any module type can be installed in any slot or group of adjacent slots so that the combination of module types within a system can be fully flexible to support a wide range of applications. Since substantially all internal communication is via radio frequency signals and the system can be and generally is configured without a backplane for internal communications, the functional composition of a system is substantially without constraint.

Function modules 114 and AC power supplies 210, when used, are inserted into the front of the system enclosure 110. The individual modules independently supply sufficient cooling and venting for operation of that module. The individual modules can separately self-perform housekeeping functions.

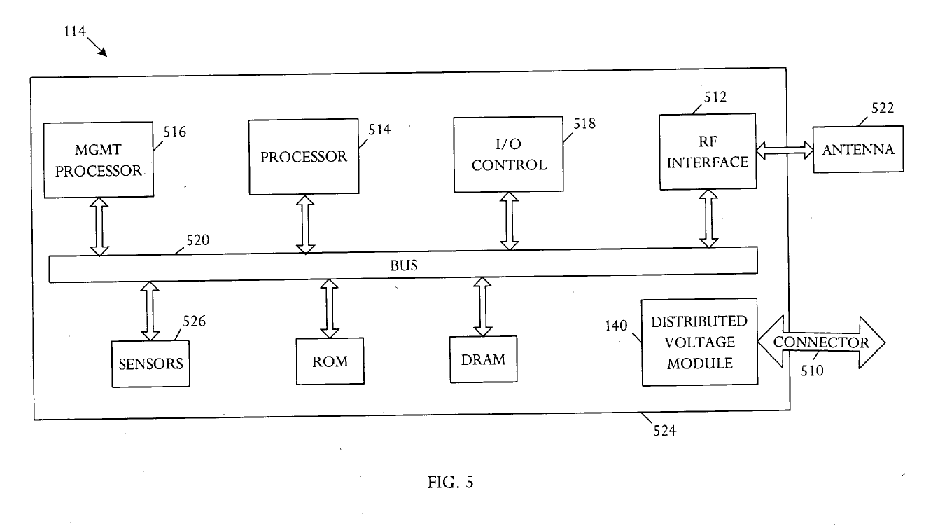

Referring to FIG. 5, a schematic block diagram illustrates an example of a functional module 114 that is suitable for usage in the illustrative RF-linked computer systems 100 and 200. The function modules 114 may be configured for similar or different functionality, as desired for particular applications. In a particular architectural example, function modules 114 have five or more general types including processor/cache modules, system memory (RAM) modules, input/output (I/O) port modules, system arbitration modules, and system management and control modules. Another type of function module 114 is a storage module such as a magnetic disk, optical disk, magnetic tape, or other type of storage device. Some systems may include long-term storage devices configured as modules within the enclosure 110. Some systems may have storage outside the enclosure 110 in a standalone storage unit or library with data transfer from the RF-linked computer system 100 to the standalone storage via optical data transmission using the I/O port modules. Some systems may combine interior and exterior storage.

In some embodiments, one or more function modules 114 may include a bootable disk drive or emulated bootstrap loading device to initiate operations. The bootable component or device may be a storage device such as a disk or may be an emulated loader such as a firmware component. In other embodiments, the bootable device may be an external device that communicates with the RF-linked computer system 100 via optical communications.

Other functional organizations are possible. System characteristics of availability, scalability, and serviceability are enhanced for functional modules 114 that have a common form.

The various function modules 114 have a uniform structure in the form of completely self-contained “customer replaceable units” (CRUs) that have a simple power delivery connector 510. The connector 510 is typically on a rear edge of the module 114 and locks into a mating connector attachment in a cavity 112. The connector 510 can be a single voltage source interface with a DC bus structure. The connector 510 couples to a distributed voltage regulator 140 that regulates voltage to meet specifications of the particular function module 114.

The function modules 114 typically include a management processor 516 that monitors operating conditions of the module 114 to determine or forecast problematic operating conditions or impending failure. The management processor 516 operates in conjunction with internal sensors 526 that measure various parameters indicative of operating conditions or failures. For example, the sensors 526 may monitor parameters such as temperature, rail level, airflow, current, frequency, and the like. In one example, the sensors 526 can monitor current level and frequency of cooling fans to determine whether a fan is nearing a failure state.

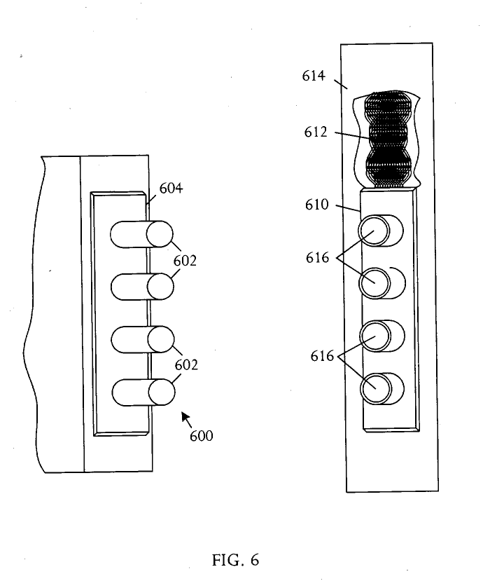

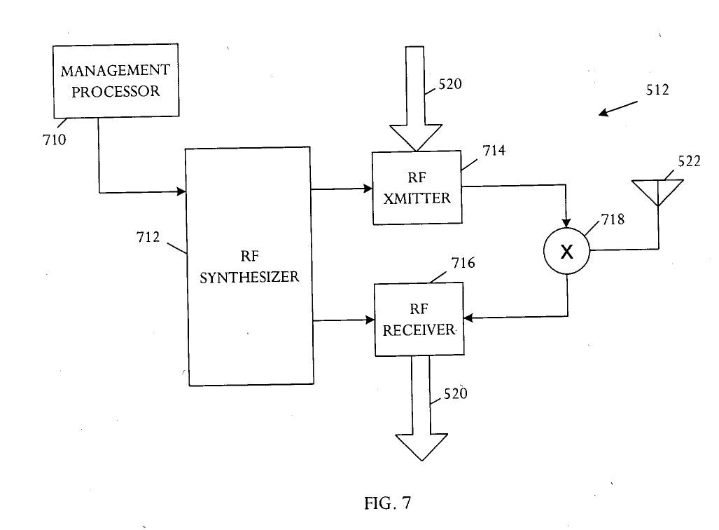

Referring to FIG. 6, a schematic pictorial diagram shows an example of a suitable connector 600 for connecting a functional module 114 to a cavity 112. The connector 600 comprises copper rods 602 enclosed in a plastic holder 604. A copper rod 602 inserts into a connector 610 in a portion of a cavity 112 at the rear of the enclosure 110. The copper rods 602 connect to a power line 612, such as a power bar or paired braids of a copper power bus, encased in an insulating sheath 614. Apertures 616 in the insulating sheath 614 permit insertion of the copper rods 602 to supply power to the function module 114. In other examples, the connectors can be conventional DC blind mate connectors with a mechanical float.

In a suitable embodiment, a connector 600 comprises a small number of copper rods 602, for example two or three, that enter into the apertures 616 on insertion. The illustrative connector 600 is very simple with structures that are wear-resistant to resist failure. Simple connectors promote reliability and availability. Other types of connectors may be used in other embodiments.

Most function modules 114 can be constructed so that the only connector is a power connector with other signals being communicated via one or more RF links. In the illustrative example, the only physical connector is a power connector at the rear edge of the module 114. I/O port modules, in contrast, add an optical link to permit communication with external components, devices, and systems.

In typical embodiments, the RF-linked computer system 100 is configured with a more limited arrangement and number of input/output interfaces than a conventional server computer system to facilitate sealing of the radio-tight enclosure. Accordingly, the RF-linked computer system 100 generally can interface to an exterior input/output bay device via fiber optic cable to attain a rich mix of input/output devices such as Ethernet, Redundant Array of Inexpensive Disks (RAID) structures, Peripheral Component Interconnect (PCI) cards, and the like. Other embodiments may include a rich I/O mix and solve leakage difficulties in other manners such as application of additional shielding.

Referring to FIG. 5 in combination with FIG. 7, the individual modules 114 also include a radio frequency (RF) interface 512 that supplies a selectable multiple-band radio communication capability. The RF interface 512 includes a management processor 710 that determines suitable communication parameters, for example frequencies and amplitudes, for communicating with other modules 114 in the enclosure 110. The management processor 710 controls a radio frequency synthesizer 712 that simultaneously generates multiple frequencies as directed by the management processor 710 for transmission to other modules 114. A RF transmitter 714 receives data from the internal data bus 520 and amplifies the generated signals to suitable amplitudes for communication in the enclosure 110. A RF receiver 716 receives radio frequency signals for utilization in the module and passes the received information to the internal data bus 520. A signal multiplexer 718 directs transmission and receipt of communication signals. The RF interface 512 couples to a broadband antenna 522 on a rear portion of the module 114 that, when the module 114 is installed, has a clear and direct line of sight to antennas in other modules 114 within the enclosure 110. The RF interface 512 supports high bandwidth channels through frequencies from very low to the highest frequencies that can be implemented in combination with usage of multiple simultaneous parallel data channels. Arbitration modules can dynamically allocate the frequency band for communications based which modules are communicating and what functions are performed in association with the communication. Various types of wireless communication protocols may be used including IEEE 802.11 wireless standards, LAN standards, Bluetooth, and the like, or nonstandard, proprietary protocols, possibly having antennas with wider bandwidth and faster communication speeds.

Referring again to FIG. 5, the radio-tight enclosure 110 can be constructed so that the interface to the exterior is limited to optical communication link, such as a fibre channel link. The radio-sealed enclosure 110 promotes and enables an interior environment with a large number of parallel channels and very large bandwidth with a capability to use the entire radio spectrum without interfering with the various bands that are allocated to various commercial, communications, broadcast, military, aircraft, and other usage.

The radio-tight enclosure 110 protects against unwanted emissions so that only limited constraints on maximum power and/or frequency are imposed. The radio-tight enclosure 110 permits internal usage of frequencies from very low to the highest practical frequencies at any reasonable power level for internal data conveyance. To reduce shielding in the radio-tight enclosure 110, the function modules 114 have a limited face area with components distributed through the remainder of a module with a relatively large depth.

Internal communications may be organized to define broadband categories for different module types or different information types. One example of a suitable frequency partition by information type allocates the frequency band from 15 to 30 GHz to data communications to and from a processor, and allocates the band from 10 to 15 GHz to data communications to and from memory. The partition allocates the band from 7 to 10 GHz to data communications to and from the I/O ports, and allocates the band from 3 to 7 GHz to memory and I/O addressing. The partition allocates the frequency band from 1 to 3 GHz to arbitration negotiations and the band less than 1 GHz to management control and reporting. Because the enclosure 110 is radio tight, any spectrum partitioning is possible with full frequency band utilization of commercial bands, military bands, and communication bands.

In some embodiments, a function module such as an I/O port module, an arbitration module or other module, can dynamically assign frequency bands for communication among modules. The module can predefine ranges of frequencies for usage communicating various particular types of data. In some examples, an encoding protocol can be used to reduce interference. For particular frequencies that can interfere, an encoding protocol can be used to avoid interference.

Very high frequency communications can be used to avoid frequency band restrictions. Parallel communications are employed to meet latency and bandwidth specifications of the internal buses 520.

The function module 114 further comprises at least one management or manageability processor 514 that functions as a channel for communicating with an arbitration module to establish presence of the module, intent to communicate, and communication sub-band designation at a level of detail suitable for organizing process and data flow. The function module 114 can include an input/output controller 518 capable of managing communications with other modules or devices outside the enclosure.

In some embodiments, the processor 514 runs an operating system independent from the other modules. Accordingly, the function modules 114 execute a distributed operating system that continues to function even when one or more modules fail. Other embodiments may use an operating system that is centralized in a single function module 114. Various intermediate levels of operating system centralization or decentralization may be implemented.

The individual function modules 114 further can include one or more management processors 516 to manage status of the module and interactions with other modules, control operations, and reporting of environment and events. In some embodiments, multiple processors are used to free system resources from overhead tasks. For example, radio devices that are integrated into or adjacent to processors, memory controllers, or I/O bridges can support a radio link for highest bandwidth data while more isolated radio devices may be configured to support lower bandwidth data. An arbitration module can dynamically configure the communication structure according to present system demands. The arbitration modules can prioritize the various data types and allocate bandwidth and frequencies accordingly.

Some function modules 114 can be contained within a shielding enclosure 524 that supplies noise immunity and reduces interference with RF communications between modules 114 internal to the enclosure 110. The function modules 114 operate in a RF rich environment and some types of components such as processors, memory, and others may have noise immunity difficulties in the field of high radio energy. Shielding 524 can be used to protect some or all modules 114 according to specifications of the particular module.

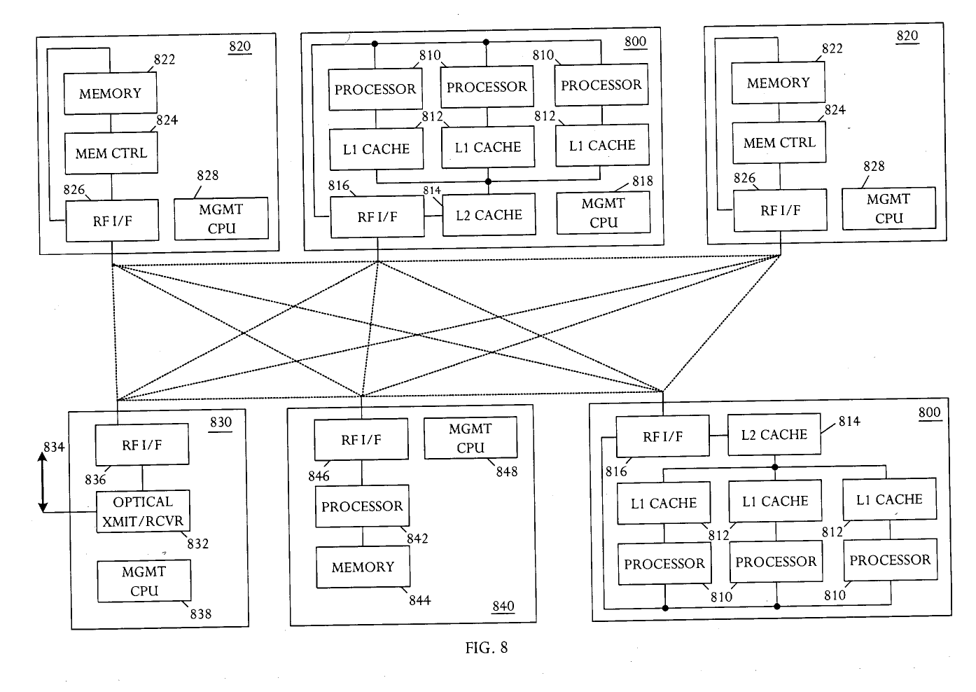

Referring to FIG. 8 is a highly simplified block diagram showing functional elements in a fabric including a plurality of suitable processor/cache function modules 800, system memory (RAM) function modules 820, I/O modules 830, and arbitration modules 840. The diagram shows structures for RF intercommunication between the modules. The individual processor/cache function modules 800 comprise one or more processors 810 with the processors associated with a level one (L1) cache 812. The processors 810 share a level two (L2) cache 814. The processors 810 communicate with other function modules 114 via a RF interface 816. Similarly the L2 cache 814 intercommunicates data with system memory (RAM) function modules via the RF interface 816. The processor/cache function modules 800 include a management processor 818 that is capable of monitoring module operating condition and determining or forecasting operating difficulties or failure.

The system memory function modules 820 comprise a memory 822 that stores data, and a memory controller 824 that controls access to data in the memory and handles data addressing, for example virtual and physical. A RF interface 826 communicates data among function modules. Various systems may include one or more processor/cache function modules 800 and one or more system memory function modules 820. Management processor 828 monitors condition of the system memory function modules 820.

The I/O module 830 comprises an optical transmitter/receiver 832 and optical data spigot 834 for communicating with exterior systems and devices. The I/O module 830 communicates internally with other function modules via RF interface 836. A management processor 838 monitors operating condition of the I/O module 830.

Arbitration module 840 comprises a processor 842 and memory 844 that operate in conjunction to arbitrate communications and functionality among the various modules under various operating conditions. The Arbitration module 840 further comprises an RF interface 846 for communicating with other modules in the system, and a management processor 848 for monitoring condition.

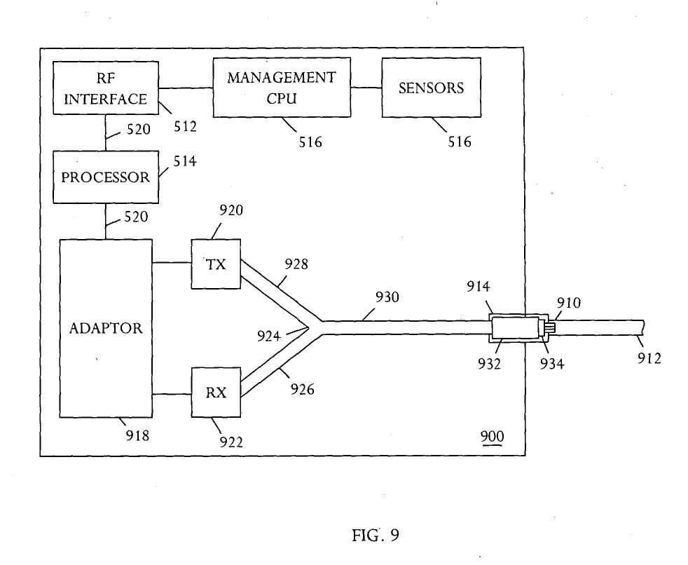

Referring to FIG. 9, a schematic block diagram shows an example of an input/output (I/O) port module 900 that is suitable for usage in the illustrative RF-linked computer systems. The I/O port module 900 includes the components of the generic functional module 114 and also includes one or more optical data spigots 910 for connecting outside the system enclosure 110. An optical data spigot 910 includes a metal tube 914 with a sufficient length to extend from the enclosure 110 for communicating with devices outside the enclosure 110. The optical data spigots 910 comprise one or more optical fibers for carrying light signals for optical communication with outside devices. The optical data spigots 910 connect to the internal buses 520 of the I/O port module 900 via a fiber-optic cable 912. The I/O port module 900 is typically a high bandwidth channel used to interconnect separate I/O card cages that communicate using any standard I/O protocol. The I/O port module 900 may support, for example, information transfer protocols selected from among a proprietary standard suitable for the described components and devices, a Transmission Control Protocol/Internet Protocol (TCP/IP), and IEEE 802 wireless standards, broadband, IEEE-1394 high-speed serial bus. The I/O port module 900 may also support the International Electrotechnical Commission (IEC-61883) Standard that describes: Isochronous Plug Control Registers, Connection Management Protocol (CMP), Function Control Protocol (FCP), Common Isochronous Packet (CIP) headers, Hypertext Transfer Protocol (HTTP GET/PUT/POST), Real-time Transport Protocol (RTP), or a proprietary protocol.

The I/O card cages and peripheral storage devices are generally housed in independent and self-powered components to avoid leakage and reduce complexity.

The I/O port module 900 can use the optical data spigot 910 to communicate with storage devices, boot devices, other computer systems, networks, and the like. The I/O port modules 900 can link the RF-linked computer system into a fabric of systems that communicate via an arbitration hub to hierarchically handle extremes of scale inherent in data sources of widely different magnitude.

Referring again to FIG. 1 in combination with FIG. 9, the RF-linked computer system 100 is further scalable on the basis that the I/O port modules 900 support communication with computer systems in other enclosures 110 enabling usage of clusters of RF-linked computer systems 100.

The I/O port module 900 enables the RF-linked computer system 100 to communicate with exterior devices and systems, both local and remote, via fiber-optic cable 912. The I/O port module 900 functions as a communications interface housed within the enclosure 110. The I/O port module 900 comprises a link adaptor 918 that interfaces the communication components with the interior processor 514. The link adaptor 918 couples to an optical transmitter 920 and an optical receiver 922 that, in turn, couple to an optical coupler 924. The optical coupler 924 has first and second arms 926 and 928, respectively, interfacing with the optical transmitter 920 and the optical receiver 922, and a leg 930 united with the arms 926 and 928. The optical coupler 924 couples to a connector 932 that can be a pluggable optical connector and interfacing with the free end of leg 930. A complementary optical connector 934 engages the connector 932.

The cavities 112 include the aperture 152 and wave guide at the rear panel of the enclosure 110 that can accept the optical spigots 910 so that the I/O port module 900 can be inserted. The aperture 152 can be positioned in any suitable location in the enclosure 110, commonly on the enclosure back panel. One suitable location is approximately mid-height in the slot, between the bus bars. The cavities can also accept other types of function modules 114 with the aperture 152 left vacant. A suitable structure for the aperture 152 is a small-diameter hole and sufficiently deep to enable the optical spigot 910 to attenuate RF emissions emanating from inside the enclosure 110. Aperture narrowness of diameter and depth can be traded off to produce a suitable radio frequency attenuation.

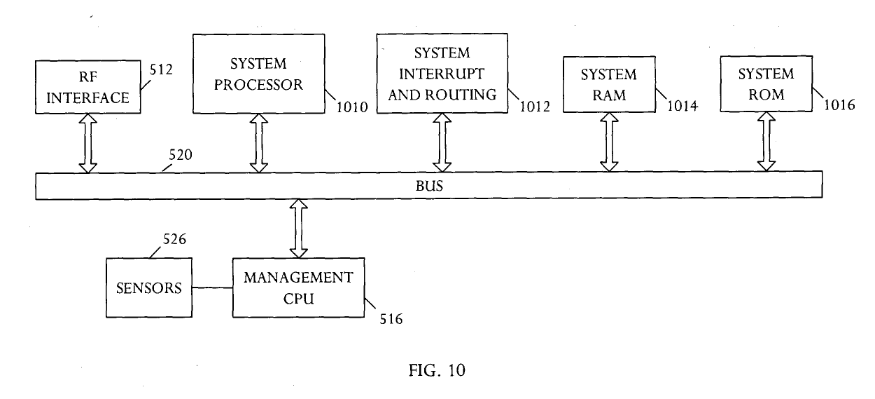

Referring to FIG. 10, a simplified block diagram illustrates an example of a system function module 1000 such as a system arbitration function module or a system management and control function module. In various embodiments, the arbitration functions and the management and control functions can be combined in the same function module. In other embodiments, the functions may be separated into different function modules. The disclosed system function module 1000 illustratively shows common operations in system management and arbitration, although other functional configurations may be used.

The system function module 1000 includes a system processor 1010 that executes various arbitration and management and control operations described hereinafter. The operations may be loaded from system ROM 1016 or system RAM 1014 for execution. Executable code may also be loaded for execution from other function modules such as memory modules or processor/cache modules. Executable code my also be loaded from external devices, either local or remote, via an I/O port module.

The system function module 1000 may also include a system interrupt and routing handler 1012 that can function as a switch for interrupt routing and interfacing to the multiple function modules that communicate via RF links within the RF-linked computer system 100. The system interrupt and routing handler 1012 tracks the potentially enormous amount of RF communication traffic that can be present at one time, and arranges data into a quantity that the system processor 1010 or multiple system processors can handle.

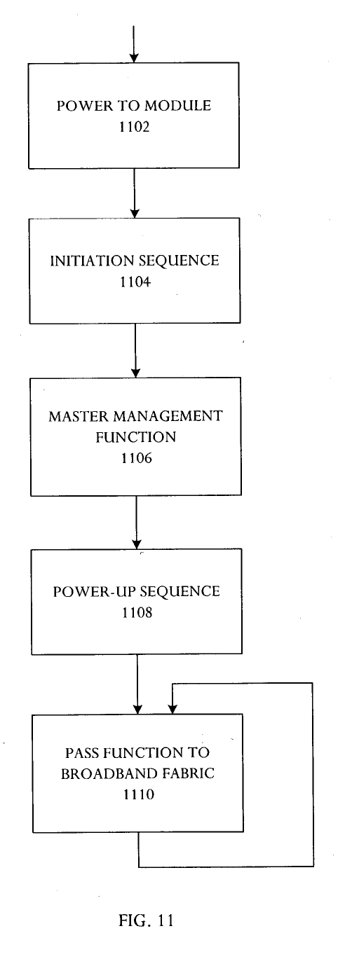

Referring again to FIG. 11, a schematic flow chart describes operation of the RF-linked computer systems. Once the system or an individual module is powered 1102, one or more of the processors in the system begins an initiation sequence 1104 that is communicated among function modules via a radio link in a specified frequency band. A master manageability function 1106 that can execute on the individual functional module or from a system management and control function module, recognizes the functional modules and instructs the modules to being a local power-up sequence, so long as a particular module is to be used in the predefined configuration. The function modules execute a power-up sequence 1108. After the power sequence is complete, a function is placed on the internal broadband fabric 1110 in a frequency band controlled by a master arbitrator module. All data signals communicated within the radio tight system enclosure 110 are secure and cannot interfere with other equipment or even be detected by other equipment.

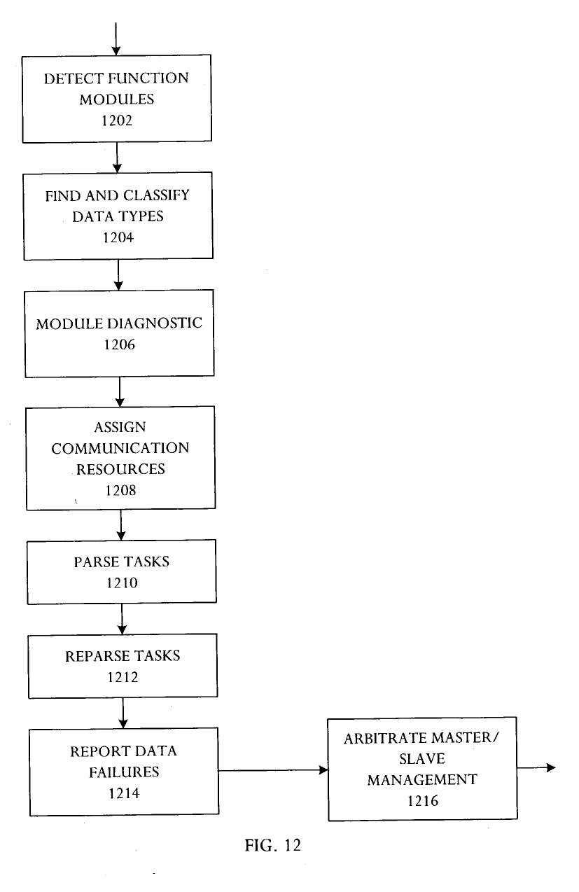

Referring to FIG. 12, a flow chart depicts operations of a suitable initialization sequence 1104. The initialization sequence is typically executed by a processor in an arbitration module, but may be executed in any suitable function module 114. The initialization sequence begins by detecting the presence of function modules 1202 that are currently operational in the system. Detection involves passive monitoring of signals communicating within the enclosure 110 and also transmitting interrogation signals and monitoring responses. After module detection, the type of data transmitted by the modules is determined and classified 1204. Data classification may take place either passively by listening to communications or actively by directly interrogating the modules. In some implementations, data classification 1204 may occur during the module detection operation 1202. A module diagnostic operation 1206 determines the operational and performance fitness or soundness of the module, for example by interrogating status registers in the module or by testing and analysis of module communications. Based on the diagnostic analysis, the initialization process assigns communication resources 1208 including assignment of bandwidth and frequency to the various modules. The initialization process parses tasks 1210 to determine whether tasks are successfully functioning and completing, and logging failures. In response to failures, tasks are reparsed 1212. During parsing 1210 and reparsing 1212, the system can track functions performed by the modules, detect failures or difficulties, and maintain coherency between operations. The system may, for example, detect a problem in a process and restart the process, discarding interim data or information, to maintain coherence. The initialization sequence then reports failure data 1214, and arbitrates master/slave management 1216.

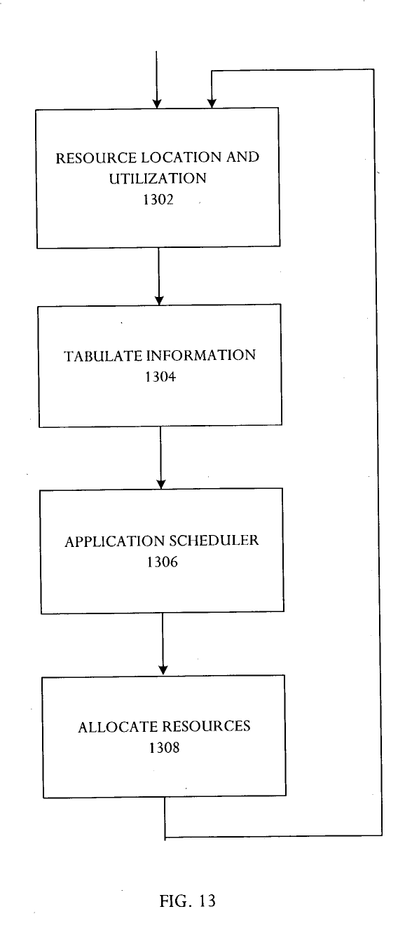

Referring to FIG. 13, a flow chart depicts actions of a suitable arbitration operation 1300 that can be executed by a function module such as a system arbitration module, system management and control module, processor module, or the like. The arbitration operation 1300 can detect location of resource location and utilization 1302 including accessing of memory capacity and utilization, processor identification and performance, I/O capabilities, and the like for the individual function modules. For modules with multiple processors including general processors, signal processors, and special purpose processors, the resource location and utilization process 1302 can allocate tasks according to capability and current utilization. A tabulate information process 1304 accumulates location and utilization data for the modules. An application scheduler 1306 posts requests from multiple applications and determines when performance of the multiple operations is due. An allocate resources process 1308 allocates applications among the various resources and modules.

Resource location and utilization detection 1302 is a continuous process with the individual modules continuously and regularly transmitting messages and signals indicative of capacity, utilization, and status.

The resource location and utilization process 1302 constructs and supplements a database that is generally stored redundantly in various system memory modules. The application scheduler 1306 and allocate resources process 1308 use the database to control the multiple applications. Managed applications can be registered locally in the arbitrator module and remotely in the database. Management functions can be distributed across multiple modules so that the system is fault tolerant, scalable, and highly available.

The arbitration operation 1300 can manage the system so that the individual modules can operate independently, without synchronization, including asynchronous messaging among the modules on a plurality of wireless channels.

The RF linked arbitration modules enable independence of all modules on the internal radio fabric. An arbitration module tracks the functionality and operations performed by the other function modules. The arbitration module can continually and regularly interrogate modules within the enclosure with requests for identification and functional characteristics. In response to the interrogation communications, the function modules report back with a report of device type for example a model and/or series number, device function, and specification. The function module response may indicate the components and resources available on the module, the status of the resources, and whether the module functionality is currently available for usage. The arbitration module and function module can enter a negotiation, developing linkage channels, allocating frequencies, and bringing the function module on-line into a radio-frequency fabric.

One or more arbitration modules control arbitration of one or more sets of function modules in a master/slave arrangement so that multiple modules may crosscheck functionality and performance among a group of modules. In a system with multiple arbitration modules, the modules can be distributed so that a particular arbitration module can service a subset or all of the function modules within a system. The arbitration modules guide and control operations of the function modules, thereby creating the radio frequency communication fabric that allocates operations to particular function modules and ensures that the operations are successfully performed.

The arbitration modules increase performance of the RF-linked computer system by determining capabilities and conditions of individual modules and distributing process load accordingly.

The arbitration modules identify critical processes and can be optionally and dynamically made redundant to protect against failure. For example, an arbitration module can determine functionality of a module, determine the functions performed, and initiate a mirror function in another module of the same type or a module of different type but with a capability to perform the desired functions.

The arbitration modules detect component failures and respond to detected failures by reconfiguring the system and processing reinitialization in the new configuration with the failed module isolated from the remaining system to avoid any information contamination. The arbitration module's capability to reconfigure the system ensures high availability, greatly reducing the possibility of system failure. The arbitration module also can update and store a log of configuration information including a list of modules that are capable of performing particular operations, the capacity for executing particular operations, and the workload of modules capable of performing the various operations. With this information, an administrator can remove faulty modules, determine future needs for modules of the various types, and replace and supplement various modules, all without bringing down the system for maintenance and upgrade.

The arbitration module can use various scheduling schemes to distribute functions that were previously performed by a faulty module. For example, the arbitration module may use round robin scheduling of the functions among modules with a capability to perform the functions. Alternatively, the arbitration module can monitor module workload and assign functions to modules with the most inactive time.

The arbitration module can monitor communications of the I/O port module to diagnose failure and performance of devices and components outside the RF-linked computer system enclosure including I/O bays, remote disks, remote storage area networks (SANs), as well as interior modules including DC bulk power supplies.

The arbitration module or other module, for example, a system management and control function module can monitor functionality and performance of all function modules and, if warranted, can respond by controlling operations of various modules. For example, a system management and control process can determine whether a particular function module is meeting performance requirements and, if not, can issue commands that reduce the burden on the ailing module and increase the workload of fully functional modules.

The management and control process interrogates the various internal system function modules. The function modules respond with an identifier, notification of capabilities and resources, and a measure of how well the functions are performed. Performance measures can include error logs, error tallies, resource utilization records, performance data counter logs, trace event logs, performance alerts, and the like. The manageability processes can alert a user to replace the defective module using remote and local reporting and identification.

In system embodiments with a plurality of system memory modules, a management and control process can have a capability to reconfigure memory to dynamically switch to other or additional memory modules while maintaining uninterrupted system operations. If additional system memory modules are available, the management and control process can reconfigure memory to recruit a memory module to replace a failing memory module so that the recruited memory assumes the address of the failed module. The management and control process can copy data from the failing module to the recruited module. During reconfiguration, the management and control process can temporarily lock wireless intercommunication with the failing and recruited modules to prevent traffic until switching is complete.

The management and control processes can increase capacity by dynamically recruiting unpowered replacement modules already contained in the enclosure or by calling for physical addition of newly installed modules into blank cavities.

In various embodiments, the management and control function can be configured in several forms. In a distributed management system, some or all function modules may include a management and control processor or process that executes on a general processor, so that a dedicated management and control module is not used. In a centralized management system, a single management and control module would supply management functions to all modules. Typically, multiple management and control modules are used in a system to supply redundancy in an available system.

In some embodiments, the arbitration function can be implemented as a table that lists modules capable of performing a set of identified functions. In response to a particular request or condition, a processor can access the table and activate a module as directed from the table to perform the appropriate function.

In other embodiments, the functional information can be stored on internal storage modules or external storage, such as a storage disks, so that the management function is highly scalable. In a highly scalable disk form, additional storage can be allocated when additional functional modules are added to a system or multiple systems are attached. For example, management in a highly scalable can be implemented using multiple storage disks such as a Redundant Array of Inexpensive Disks (RAID) structure in which management information, executable code, and data can be redundantly stored and communicated via optical communication for execution by any processor on a function module. In some examples, the processor can execute in a dedicated management and control module. In other examples, the processor may be any type of function module. The highly scalable disk form is useful in forming a fabric of systems in which functionality and information are held as a virtual system on a plurality of physical systems.

The management function, whether confined to a particular management and control module or modules or distributed among processors of various function module types, dictates functionality of the various function modules. The management function identifies function modules capable of performing an impending operation, determines whether the capable function modules are currently operational and available, and issues a command for a suitable module to perform the operation. If a particular module fails, the management and control module can remove the faulty module from a list of available modules, generate a notification signal identifying the failed module, and update a list of replacement modules that may be available to perform functions of the failed module. In some embodiments, the management and control module can deactivate a faulty function module, terminate the communication capability of the faulty module, or mask the capability of a function module to generate wireless request, grant, and interrupt signals.

While the invention has been described with reference to various embodiments, it will be understood that these embodiments are illustrative and that the scope of the invention is not limited to them. Many variations, modifications, additions and improvements of the embodiments described are possible. For example, the cabinet can be configured in any suitable shape, geometry, and size with any suitable arrangement and capacity of function modules. The modules can have any suitable functionality and combinations of functionality. In some embodiments, many different varieties of function modules may be used depending on the overall functionality desired in the system. In other embodiments, a single uniform type of function module may be used in all slots so that each module has full functionality, for example including processor, memory, input/output capabilities, as well as including arbitration and management functionality.

What is claimed is:

1. A computer system comprising:
a radio-tight enclosure;
a plurality of cavities contained within the enclosure, the plurality of cavities capable of accepting and holding multiple function modules;
one or more function modules capable of insertion into the cavities and comprising a radio frequency communication system capable of intercommunicating in multiple parallel channels and wide bandwidth within the enclosure; and
one or more optical communication links capable of communicating to devices and systems exterior to the enclosure.

2. A computer system according to claim 1 wherein:
the one or more optical communication links are the only communication link between the computer system and devices and systems exterior to the enclosure.

3. A computer system according to claim 1 wherein:
the multiple parallel channels and wide bandwidth within the enclosure extend across the entire radio spectrum, the radio tight enclosure preventing interference with bands allocated to commercial, communications, broadcast, military, aircraft, and other allocated frequency bands.

4. A computer system according to claim 1 wherein:
the function modules further comprise:
one or more radio frequency interfaces; and
one or more antennas coupled to the one or more radio frequency interfaces, the radio frequency interfaces and the antennas capable of intercommunicating with function modules within the enclosure, forming a virtual bus comprising a plurality of dynamically-modifiable parallel wireless communication channels.

5. A computer system according to claim 1 wherein:
the plurality of function modules comprise one or more function modules that can execute a system arbitration functionality comprising:
a capability to detect presence of function modules;
a capability to assess functionality and/or performance of the function modules; and
a capability to assign communication resources and parallel channels for intercommunication among function modules.

6. A computer system according to claim 1 wherein:
the one or more function modules can execute a system arbitration functionality comprising:
a capability to assign wireless communication resources and channels among the plurality of function modules so that the function modules operate mutually independently on a wireless fabric in a backplane-free and communication connector-free internal environment with the function modules operating as cross-linked and autonomous system contributors.

7. A computer system comprising:
a radio-tight enclosure; and
a plurality of function modules capable of insertion into the radio tight enclosure, the function modules further comprising:
one or more radio frequency interfaces; and
one or more antennas coupled to the one or more radio frequency interfaces, the radio frequency interfaces and the antennas capable of intercommunicating with function modules within the enclosure, forming a virtual bus comprising a plurality of dynamically-modifiable parallel wireless communication channels.

8. A computer system according to claim 7 wherein:
the function modules intercommunicate only by wireless communication without physical internal buses coupling the function modules.

9. A computer system according to claim 7 wherein:
the plurality of function modules comprise one or more function modules that can execute system arbitration functionality comprising:
a capability to detect presence of function modules;
a capability to assess functionality and/or performance of the function modules; and
a capability to assign communication resources and parallel channels for intercommunication among function modules.

10. A computer system according to claim 7 further comprising:
one or more power lines; and
an optical communication channel capable of interfacing to systems and devices outside the enclosure.

11. A computer system according to claim 10 wherein:
the radio-tight enclosure has radio tightness at least partially on the basis that breaches to the outside are limited to a single optical I/O port and limited filtered power lines into the enclosure.

12. A computer system comprising:
a radio-tight enclosure; and
a plurality of function modules capable of intercommunicating within the enclosure via multiple parallel radio frequency channels, the plurality of function modules comprising one or more function modules that can execute system arbitration functionality comprising:
a capability to detect presence of function modules;
a capability to assess functionality and/or performance of the function modules; and
a capability to assign communication resources and parallel channels for intercommunication among function modules.

13. A computer system according to claim 12 wherein the system arbitration capability further comprises:
a capability to parse tasks.

14. A computer system according to claim 12 wherein the system arbitration capability further comprises:
a capability to detect and report failure data.

15. A computer system according to claim 12 wherein the system arbitration capability further comprises:
a capability to arbitrate master/slave management.

16. A computer system according to claim 12 wherein the system arbitration capability further comprises:
a capability to assign wireless communication resources and channels among the plurality of function modules so that the function modules operate mutually independently on a wireless fabric in a backplane-free and communication connector-free internal environment with the function modules operating as cross-linked and autonomous system contributors.

17. A computer system according to claim 12 wherein:
the function modules intercommunicate only by wireless communication without physical internal buses coupling the function modules.

18. A computer system comprising:
a plurality of function modules;
a radio tight enclosure that contains a plurality of cavities capable of accepting the plurality of function modules, the function modules being capable of intercommunicating inside the enclosure by wireless communication;
a power line; and
an optical communication channel capable of interfacing to systems and devices outside the enclosure.

19. A computer system according to claim 18 wherein:
the radio-tight enclosure has radio tightness at least partially on the basis that breaches to the outside are limited to a single optical I/O port and limited power lines into the enclosure.

20. A method of computing comprising:
communicating among a plurality of function modules within a radio-tight enclosure via multiple parallel radio frequency channels;
detecting presence of one or more of the plurality of function modules;
assessing functionality and/or performance of the detected function modules; and
assigning communication resources and parallel channels for intercommunication among function modules based on the assessed functionality.

21. A method according to claim 20 further comprising:
scheduling a plurality of applications for execution by the function modules;
determining resources and utilization of the resources within the function modules; and
allocating the plurality of applications among the resources.

22. A method according to claim 20 further comprising:
detecting failure data; and
reporting the failure data.

23. A method according to claim 20 further comprising:
assigning wireless communication resources and channels among the plurality of function modules so that the function modules operate mutually independently on a wireless fabric in a backplane-free and communication connector-free internal environment with the function modules operating as cross-linked and autonomous system contributors.

24. A computer system comprising:
a radio-tight enclosure;
a plurality of function modules capable of insertion into the radio-tight enclosure;
means for wirelessly communicating among the plurality of function modules interior to the radio-tight enclosure; and
optical means for communicating between the plurality of function modules interior to the radio-tight enclosure and exterior devices.

25. A computer system according to claim 24 further comprising:
means for communicating among a plurality of function modules within a radio-tight enclosure via multiple parallel radio frequency channels;
means for detecting presence of one or more of the plurality of function modules;
means for assessing functionality and/or performance of the detected function modules; and
means for assigning communication resources and channels to intercommunicate among the plurality of function modules based on the assessed functionality.

26. A computer system comprising:
a radio-tight enclosure;
a plurality of cavities contained within the enclosure, the plurality of cavities capable of accepting and holding multiple function modules;
one or more function modules capable of insertion into the cavities and comprising a radio frequency communication system capable of intercommunicating in multiple parallel channels and wide bandwidth within the enclosure; and
a power delivery infrastructure coupled to the plurality of cavities for supplying power to the one or more function modules, the power delivery infrastructure comprising the only hardware common to all function modules, the power delivery infrastructure being redundant and replaceable without disrupting computer system operation.
